(19) United States
(12) Patent Application Publication
(10) Pub. No.: US 2020/0053833 A1
(43) Pub. Date: Feb. 13, 2020

(54) METHOD AND DEVICES FOR TRANSMITTING DATA BETWEEN A FIRST NETWORK AND A SECOND NETWORK OF A RAIL VEHICLE

(71) Applicant: SIEMENS MOBILITY GMBH, MUENCHEN (DE)

(72) Inventor: THORSTEN BRAUN, BUBENREUTH (DE)

(21) Appl. No.: 16/492,247

(22) PCT Filed: Feb. 13, 2018
(86) PCT No.: PCT/EP2018/053491

§ 371 Date: Sep. 9, 2019

(30) Foreign Application Priority Data
Mar. 9, 2017 (DE) 10 2017 203 898.5

(51) Int. Cl. H04W 88/16; H04L 29/06; H04L 12/66

(52) U.S. Cl. CPC H04W 88/16; H04L 63/0209; H04L 2012/40273; H04L 63/20; H04L 12/66; H04L 63/0227

(57) ABSTRACT

A gateway device, a communication method and to a communication system for a vehicle, in particular a rail vehicle improve the transmission of data between a first network of the vehicle and a second network of the vehicle. The gateway device is configured to control the transmission of data between the first network of the vehicle and the second network of the vehicle in accordance with the state of the vehicle.

The invention relates to a gateway device, a communication method and a communication system for a vehicle, in particular a rail vehicle.

Gateway devices are known in principle for connecting networks, in particular data networks, which are based on different network protocols.

A solution for connecting a first and second network is described in DE 10 2015 108 109 A1. Herein, for unidirectional transmission of data in a system comprising a first and a second network, a data diode is connected between a transmitter of the first network and a receiver of the second network.

DE 10 2010 052 486 B4 describes a solution for the transmission of data between a system relevant for the safety of the vehicle and the passengers thereof (in particular the vehicle control system) and a passenger information system that can be activated outside the vehicle.

Against this background, it is the object of the invention to improve secure transmission of data between a first network and a second network.

This object is achieved by a gateway device for a vehicle, in particular a rail vehicle, which is designed to control transmission of data between a first network of the vehicle and a second network of the vehicle as a function of the state of the vehicle.

The invention is based on the knowledge that a connection of two networks by means of a data diode only enables the transmission of data in one direction. In the case of certain network configurations, in particular when the second network is to be protected from an unwanted transmission of data from the first network, flexibility in the transmission of data is desirable in order to enable certain items of data to be transmitted in both directions (i.e. from the first network to the second network or from the second network to the first network). According to the invention, the degree to which transmission of data in one direction or another is to be allowed is controlled as a function of the state of the vehicle. This increases flexibility in the transmission of data between the first and second network. For example, certain items of data can be transmitted in a predetermined state of the vehicle from the first network into the second network, which in another state of the vehicle is not allowed for transmission from the operator network to the control network (in other words: data flows permitted in one predetermined state of the vehicle are prohibited in another state of the vehicle). Herein, coupling data transmission to the state of the vehicle provides a hurdle that ensures sufficient security for the network to be protected.

The first and second network are preferably in each case designed as a communication or data network.

According to a preferred embodiment of the gateway device according to the invention, the first network comprises an operator network and the second network comprises a control network.

The person skilled in the art will understand the term “control network” to mean a network that comprises one or more components for controlling the vehicle. This understanding is based on the knowledge that, in modern-day rail vehicles—in addition to conventional instrumentation-and-control functions (e.g. drive and braking functions)—numerous tasks are carried out by automated means. These comprise, for example, the operation and management of a system for outputting information to passengers and on-board crew, automated operation of sanitary facilities, management of communication between the rail vehicle and the land-side, etc. The corresponding components are connected to one another via the control network by means of control and communication technology.

Furthermore, the person skilled in the art will understand the term “operator network” to mean a network that is physically and/or logically separated from the control network. For example, to monitor the interior and exterior regions of the rail vehicle, the passenger information system (PIS) and/or the camera monitoring system is connected to the operator network by means of data technology (CCTV: closed circuit television). The corresponding components of the PIS or camera monitoring system are connected to one another via the operator network by means of communication technology.

The basic problem with this embodiment arises from the desire to enable dataflows between the control network and the operator network. Despite the physical and/or logical separation, this kind of data transmission is necessary since, on the one hand, functional units of the operator network require instrumentation-and-control data from the control network for their operation and, on the other, the control network collects and evaluates state data from functional units of the operator network. One possible example is a display showing the train speed on a passenger information system display. A further possible example is the collection of diagnostic data from operator-network functional units by a unit connected to the control network. Such a unit can be a system server (e.g. SP SR: SIBAS PN system server; SIBAS PN: SIBAS PROFINET; SIBAS: Siemens Railway Automation System).

In a preferred development of the embodiment, the vehicle is designed to adopt as a state of the vehicle at least a maintenance state, which is intended for the maintenance of the vehicle, and an operating state, which is intended for the operation of the vehicle, wherein the gateway device is designed only to allow the transmission of predetermined data from the operator network to the control network in a maintenance state. The vehicle is preferably able to adopt further states in addition to the operating state and maintenance state, for example a start-up state and/or a shut-down state.

In a further preferred development, the gateway device is designed to receive state information representing the state of the vehicle from the control network and to control the transmission on the basis of the state information. The state information is preferably sent by a server of the control network and received by means of the gateway device. Furthermore, the gateway device is preferably designed only to receive the state information from the control network. Then, state information received from the operator network will not be taken into account. This has the advantage that an attempted attack based on state information generated by third parties from the operator network can be avoided.

In a further preferred embodiment, the gateway device according to the invention comprises a first firewall unit, which is intended for a data interface facing the operator network and which is designed to forward or discard data intended for transmission from the operator network to the control network using a first firewall ruleset and/or a second firewall unit, which is intended for a data interface facing the control network and which is designed to forward or discard data intended for transmission from the control network to the operator network using a second firewall ruleset.

In other words: the first and/or second firewall unit is used to filter data that is input at the respective data interface. The data interface is preferably designed as an Ethernet interface. The first or second firewall unit is preferably designed to load the first or second firewall ruleset on vehicle start-up. Further preferably, the respective firewall unit has a firewall ruleset before start-up, said ruleset being only suitable for the transmission of data during the start-up phase.

According to a further preferred embodiment, the gateway device according to the invention comprises an intrusion-detection unit, which is designed to monitor at least data intended for transmission from the operator network to the control network. The intrusion-detection unit is preferably designed as an intrusion-detection system and is used to detect attacks, attempts at abuse and/or security violations that affect the control network. The monitoring preferably comprises logging events, compiling and sending workshop messages and/or compiling and sending operational messages. Further preferably, the monitoring comprises filtering or discarding data if the data does not satisfy predefined properties and/or specifications. Further preferably, the intrusion-detection unit is designed to monitor data intended for transmission from the control network to the operator network (herein, the intrusion-detection unit is used to detect attacks, attempts at abuse and/or security violations that affect the operator network).

According to a further preferred embodiment, the gateway device according to the invention comprises an intrusion-prevention unit, which is designed to prevent the transmission of data intended for an unwanted access to the control network. The intrusion-prevention unit is preferably designed as an intrusion-prevention system (IPS) and is used to prevent attacks, attempts at abuse and/or security violations that affect the control network. Transmission is preferably prevented in that data that does not satisfy a predetermined property and/or specification filtered or discarded. The intrusion-prevention unit as further preferably designed to prevent transmission of data originating from the control network and intended for an unwanted intrusion in the operator network.

The intrusion-detection unit and intrusion-prevention unit are preferably formed by a common component of the gateway device. Further preferably, the intrusion-detection unit forms an element of the intrusion-prevention unit. In respect of its functions, the intrusion-prevention unit comprises the functions of the intrusion-detection unit and—in addition to monitoring data—also provides functions for preventing the transmission of data.

According to a further preferred embodiment, the intrusion-detection unit is designed to carry out the monitoring using a first detection ruleset and/or the intrusion-prevention unit is designed to carry out the prevention using a first prevention ruleset.

According to a further preferred embodiment, the gateway device according to the invention comprises a limiting unit, which is designed to limit data traffic between the operator network and the control network. The person skilled in the art will preferably understand the term “data traffic” (which the person skilled in the art frequently also refers to as traffic) as meaning the amount of data transmitted at each point of time. The limiting unit is further preferably designed to limit data traffic originating from the operator network intended for the transmission to the control network. The limiting unit ensures that the transmission of data to the control network is achieved from the viewpoint of maximum bandwidth and/or a burst. The limiting unit is further preferably designed to limit data traffic originating from the control network intended for transmission to the operator network.

In a further preferred development, the gateway device comprises a vehicle-state managing unit, which is designed to provide the first firewall unit of the above-described type with a third firewall ruleset as a function of the state of the vehicle, the intrusion-detection unit of the above-described type with a second detection ruleset as a function of the state of the vehicle and/or the intrusion-prevention unit of the above-described type with a second prevention ruleset as a function of the state of the vehicle.

The use of the vehicle-state managing unit has the advantage that it enables individual wishes of an operator of the vehicles to be taken into account in that appropriately adapted rulesets for the firewall unit, the intrusion-detection unit and/or intrusion-prevention unit are loaded into the vehicle-state managing unit.

According to a further preferred development, the first firewall unit is designed to allow, on the basis of the third firewall ruleset, extended access from the operator network to the control network, the intrusion-detection unit is designed to allow, on the basis of the second detection ruleset, extended access from the operator network to the control network and/or the intrusion-prevention unit is designed to allow, on the basis of the second prevention ruleset, extended access from the operator network to the control network. The person skilled in the art will understand the wording “extended access” as meaning that predetermined data, which is rejected by the firewall unit using the first firewall ruleset and/or using the first prevention ruleset is forwarded by the intrusion-prevention unit using the third firewall ruleset by the firewall unit and/or the second prevention ruleset. This enables particularly simple and secure transmission of data between the first and second network to be controlled as a function of the state of the vehicle.

In a preferred development of the gateway device, the provision of the third firewall ruleset, second detection ruleset and/or second prevention ruleset can only be initiated by information originating from the control network, in particular the above-described state information. A design of this kind has the advantage that protection of the control network is achieved in that only information originating from the control network is able to initiate a change to data transmission in the direction of the control network. In other words: extended access to the control network can only be initiated by the actual control network.

Preferably, the state information received from gateway device is processed by the vehicle-state managing unit.

In a further preferred embodiment, the gateway device comprises an application-layer gateway unit, which is designed to convey the data between the first and second network. The person skilled in the art will preferably understand the term “application-layer gateway unit” to mean a unit, used to forward, analyze and/or convert data at the application level of the OSI reference model. Further preferably, the transmission of data by means of the application-layer gateway unit is controlled such that an absence of adverse effects between a source of the data (first or second network) and a sink of the data (second or first network) is achieved.

The person skilled in the art will preferably understand the application-layer gateway unit to be formed by an application-layer gateway. Further preferably, the application-layer gateway-unit is connected to the system server (e.g. SP SR) on the side facing the control network by means of data technology. Further preferably, the application-layer gateway unit is connected to a server of the operator network by means of data technology.

The person skilled in the art will preferably understand the term “convey” to mean that the application-layer gateway unit represents a conveying instance, which, as a proxy, forwards data intended for transmission between the first and second network. For example, preferably there is no direct data connection between the first and second network. Instead, the data connection between the application-layer gateway unit and the operator network is provided by means of a first connection to the control network and by means of a second connection to the operator network.

The invention further relates to a communication method for a vehicle, in particular a rail vehicle, comprising: transmitting data between a first network of the vehicle and a second network of the vehicle and controlling the transmission between the first and second network by means of a gateway device as a function of the state of the vehicle.

The invention further relates to a communication system for a vehicle, in particular a rail vehicle, comprising: a first network of the vehicle and a second network of the vehicle and a gateway device, which is designed to control transmission of data between the first and second network as a function of the state of the vehicle.

In a preferred embodiment of the communication system, the first network comprises an operator network and the second network a control network.

In a preferred development of the communication system, the vehicle is designed to adopt as a state of the vehicle at least a maintenance state, which is intended for the maintenance of the vehicle, and an operating state, which is intended for the operation of the vehicle, wherein the gateway device is designed only to allow the transmission of predetermined data from the operator network to the control network in the maintenance state.

In a further preferred development of the communication system the gateway device is designed to receive state information representing the state of the vehicle from the control network and to control transmission on the basis of the state information.

In a particularly preferred embodiment of the communication system, the operator network comprises a wireless access point, which provides wireless access to the operator network for a mobile terminal, wherein the gateway device is designed to allow the mobile terminal to access the control network by means of data technology in the maintenance state. This enables maintenance staff, for example using a maintenance PC as a terminal, to perform maintenance tasks in the control network using the wireless access point. Access via the wireless access point increases ease of handling for the maintenance staff.

In a further preferred embodiment of the communication system the gateway device comprises a first firewall unit, which is intended for a data interface facing the operator network and which is designed to forward or discard data intended for transmission from the operator network to the control network using a first firewall ruleset and/or a second firewall unit, which is intended for a data interface facing the control network and which is designed to forward or discard data intended for transmission from the control network to the operator network using a second firewall ruleset.

According to a further preferred embodiment of the communication system, the gateway device comprises an intrusion-detection unit, which is designed to monitor at least data intended for transmission from the operator network to the control network.

According to a further preferred embodiment of the communication system, the gateway device comprises an intrusion-prevention unit, which is designed to prevent transmission of data intended for an unwanted access to the control network.

In a further preferred embodiment of the communication system, the intrusion-detection unit is designed to carry out the monitoring using a first detection ruleset and/or the intrusion-prevention unit is designed to carry out the prevention using a first prevention ruleset.

According to a further preferred embodiment of the communication system, the gateway device comprises a limiting unit, which is designed to limit data traffic between the operator network and the control network.

In a further preferred development of the communication system, the gateway device comprises a vehicle-state managing unit, which is designed to provide the first firewall unit of the above-described type with a third firewall ruleset as a function of the state of the vehicle, to provide the intrusion-detection unit of the above-described type with a second detection ruleset as a function of the state of the vehicle and/or to provide the intrusion-prevention unit of the above-described type with a second prevention ruleset as a function of the state of the vehicle.

According to a further preferred development of the communication system, the first firewall unit is designed to allow, on the basis of the third firewall ruleset, extended access from the operator network to the control network, the intrusion-detection unit is designed to allow, on the basis of the second detection ruleset, extended access from the operator network to the control network and/or the intrusion-prevention unit is designed to allow, on the basis of the second prevention ruleset, extended access from the operator network to the control network.

In a preferred development of the communication system, the provision of the third firewall ruleset, second detection ruleset and/or second prevention ruleset can only be initiated by information originating from the control network, in particular the above-described state information.

The invention further relates to a rail vehicle, which comprises a communication system of the above-described type.

With respect to embodiments, developments, details of implementation and/or advantages of the communication method according to the invention and the communication system according to the invention, reference is made to the description of the corresponding features of the gateway device.

An exemplary embodiment of the invention is now explained with reference to the drawings, in which:

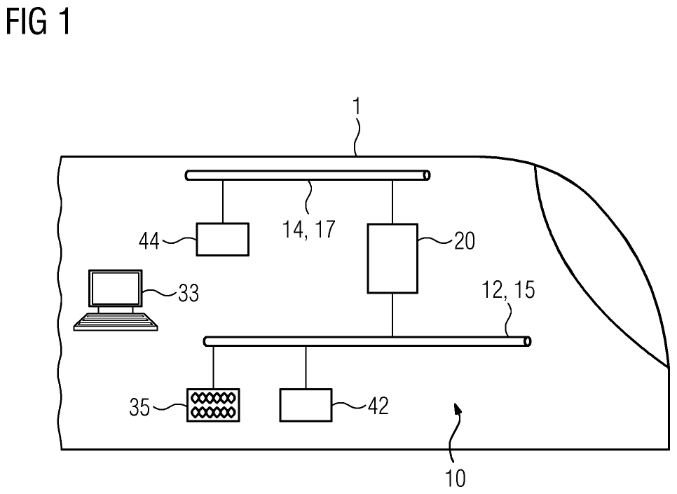

FIG. 1 shows a schematic structure of a communication system according to an exemplary embodiment of the invention,

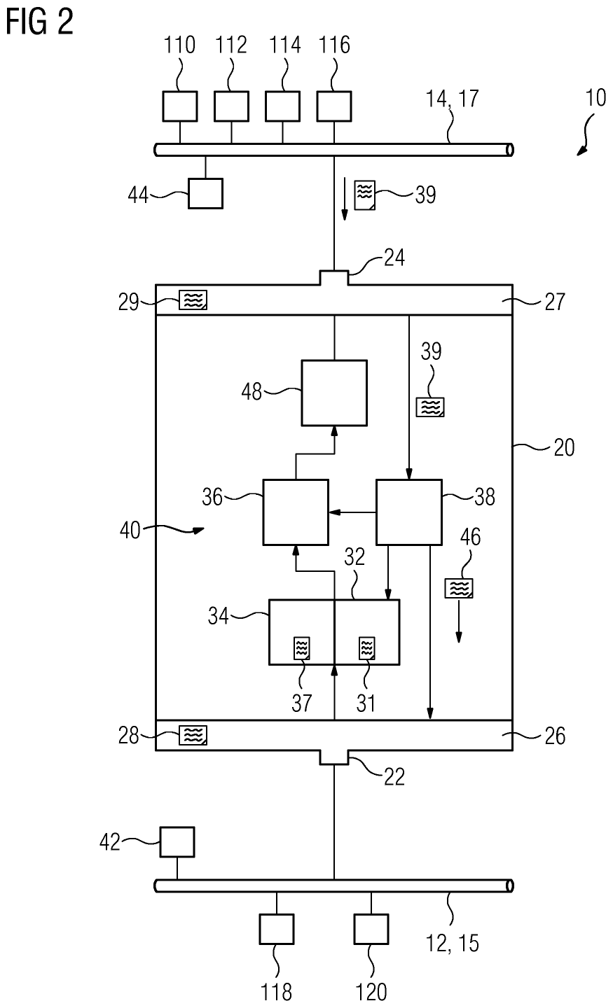

FIG. 2 shows a functional structure of the gateway device shown in FIG. 1 and

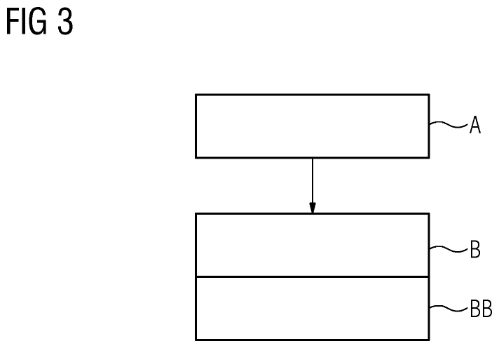

FIG. 3 shows a schematic flow diagram of a communication method according to the invention according to an exemplary embodiment.

FIG. 1 shows a rail vehicle 1 in a schematic side view. The rail vehicle 1 is designed as a group of a plurality of railcars, which are mechanically coupled to one another and form a train unit. In the embodiment under consideration, the rail vehicle 1 is designed as a so-called multiple unit train.

The rail vehicle 1 has a communication system 10, which comprises at least a first network 12 and a second network 14. The first network 12 is an operator network 15 of the rail vehicle 1 and the second network 14 is a control network 17 of the rail vehicle 1. The operator network 15 and the control network 17 are in each case designed as Ethernet networks.

The control network 17 is configured for operation in accordance with the PROFINET standard. The control network 17 comprises a train bus, for example an Ethernet Train Backbone (ETB), and a PROFINET ring to which at least one subsystem control unit 110, 112, 114 or 116 intended to control one or more operating resources of the vehicle is connected. The subsystem control units 110, 112, 114 and 116 are in each case intended to control a task in connection with the functionality assigned to the respective subsystem. The subsystem control units 110, 112, 114 and 116 are in each case connected to the control network 17. In the exemplary embodiment shown in FIG. 1, the subsystem control unit 110 is depicted as drive control, the subsystem control unit 112 as a brake control, the subsystem control unit 114 as a control for the vehicle door system and the subsystem control unit 116 as a control for the train protection system.

The operator network 15 is physically and/or logically separated from the control network 17. For example, a passenger information system 118 and a camera monitoring system 120 is connected to the operator network 15 by means of data technology to monitor the interior and exterior regions of the rail vehicle. The corresponding components of the passenger information system 118 and the camera monitoring system 120 are connected to one another via the operator network 15 by means of communication technology.

A gateway device 20 is used to transmit data between the first network 12 and the second network 14 according to a method step A. The gateway device 20 has a first data interface, in particular an Ethernet interface 22, via which the gateway device 20 is linked to the operator network 15. The gateway device 20 has a second data interface, in particular an Ethernet interface 24, via which the gateway device 20 is linked to the control network 17.

In a method step B, the gateway device 20 controls the transmission of data between the control network 17 and the operator network 15 as a function of the state of the vehicle. The rail vehicle 1 can adopt as a state of the vehicle an operating state, which is intended for the operation, for example a travel operation, of the rail vehicle 1. In addition, the rail vehicle 1 can adopt a maintenance state, which is intended for the maintenance of the vehicle, a start-up state and/or a shut-down state. In a method step BB, the gateway device only allows the transmission of predetermined data emanating from the operator network 15 to the control network 17 in the maintenance state. In other words: predetermined data, which is not allowed for transmission emanating from the operator network 15 to the control network 17 in the operating state, can be transmitted in the maintenance state.

The state of the vehicle is determined by means of the gateway device 20 using state information 39. The state information 39 is emitted by a system server 44 of the control network 17 and received by the gateway device 20.

Data that emanates from the operator network 15 and enters the gateway device 20 via the first Ethernet interface 22 and is intended for transmission to the control network 17 is filtered by a firewall unit 26. The filtering by means of the firewall unit 26 takes place in that the data is forwarded or discarded using a first firewall ruleset 28.

Data that emanates from the control network 17 and enters the gateway device 20 via the second Ethernet interface 24 and is intended for transmission to the operator network 15 is filtered by a firewall unit 27. The filtering by means of the firewall unit 27 takes place in that the data is to forwarded or discarded using a second firewall ruleset 29.

Data that emanates from the operator network 15 and is intended for transmission to the control network 17 and passes the firewall unit 26 is received by an intrusion-detection unit 32, which is designed as an intrusion-detection system, and an intrusion-prevention unit 34, which is designed as an intrusion-prevention system.

The intrusion-detection unit 32 filters or discards data traffic when it detects a violation of a prespecified pattern and/or a rule. The intrusion-detection unit 32 monitors data using a first detection ruleset 31. If a comparatively significant violation of a prespecified pattern and/or a rule is detected by the intrusion-detection unit 32, in addition the Ethernet interface 22 to the operator network 15 is disconnected.

The intrusion-prevention unit 4 filters or discards data from a sender if this data does not satisfy a prespecified property and/or specification. The intrusion-prevention unit 32 prevents transmission of data using a first prevention ruleset 37. Received data, in particular data transmitted via an OPC connection (OPC: Open Platform Communications) is analyzed by means of deep packet inspection with respect to the observance of specifications. In addition, the intrusion-prevention unit 34 analyzes received data that is transmitted via an HTTP connection. A HTTP connection is, for example, established when the vehicle adopts a maintenance state. In a maintenance state, the HTTP connection is for example used to retrieve workshop messages. The retrieval is, for example, initiated by a member of the maintenance staff who accesses the control network 17 using a maintenance PC 33 via an access interface 35 on the operator network 15. In addition, HTTP connection can be used for software deployment for components such as a system server and/or a subsystem control unit 110, 112, 114 or 116.

The intrusion-detection unit 32 and the intrusion-prevention unit 34 are designed to log an event representing an intrusion and in addition to compile and sent a workshop message intended to be read during the course of maintenance and also to compile and sent an operational message intended to be read during the operation of the rail vehicle 1 is intended. The operational message can be provided to a rail vehicle driver or conductor by means of a man-machine interface with a display.

Data emanating from the operator network 15 and intended for transmission to the central network 17 and which passes the intrusion-detection unit 32 and an intrusion-prevention unit 34 is received by an application-layer gateway-unit 36. The application-layer gateway unit 36 is designed to analyze data at the application level of the OSI reference model and optionally convert it and forward it. The application-layer gateway unit 36 is embodied as an application-layer gateway.

The application-layer gateway unit 36 maintains a connection to a train server 42 of the operator network 15 and a further connection to the system server 44 of the control network 17 and is used as a conveying instance 40 between the operator network 15 and control network 17. In other words: there is no direct data connection between the train server 42 and the system server 44. For example, a data connection of the train-Servers 42 for transmission of data to the control network 17 is terminated at the application-layer gateway unit 36 and a new data connection is initiated with the system server 44.

A vehicle-state managing unit 38 of t gateway device 20 is designed to receive process data or process signals from the control network 17. The process data or process signals can be used by the vehicle-state managing unit 38 as the basis for determining whether or not the rail vehicle 1 adopts a maintenance state as a state of the vehicle. Process data or process signals that influence the provision of the firewall ruleset are received by the vehicle-state managing unit 38 exclusively from the control network 17.

The vehicle-state managing unit 38 in particular receives state information 39 representing the state of the vehicle from the system server 44 of the control network 17. The vehicle-state managing unit 38 determines the state of the vehicle on the basis of the state information 39. If the maintenance state is determined as a state of the vehicle, the vehicle-state managing unit 38 provides the firewall unit 26 with a third firewall ruleset 46 on the basis of which extended access from the operator network 15 to the control network 17 is enabled.

In other words: while the rail vehicle 1 adopts the operating state as a state of the vehicle, the firewall unit 26 uses the firewall ruleset 28 to filter data. When the rail vehicle 1 adopts the maintenance state, the vehicle-state managing unit 38 provides the third firewall ruleset 46 to the firewall unit 26. The firewall unit 26 uses the third firewall ruleset 46 to filter the data.

The intrusion-detection unit 32 or the intrusion-prevention unit 34 can also be provided with an amended ruleset, for example a second detection ruleset or a second prevention ruleset by means of the vehicle-state managing unit 38 for the maintenance state. Alternatively or additionally, a ruleset used by the firewall unit 27, the intrusion-detection unit 32 and the intrusion-prevention unit 4 for the maintenance state can be deactivated by the vehicle-state managing unit 38 in order to allow extended access from the operator network 15 to the control network 17.

For example, the provision of a third ruleset 46 to the firewall unit 27 and the second detection ruleset to the intrusion-detection unit 32 and the second prevention ruleset to the intrusion-prevention unit 34 enables maintenance staff to access the control net 17 via an access interface of the operator network 15 using a maintenance PC 33 (PC: personal computer).

The gateway facility 38 also comprises a limiting unit 48, which is designed to limit data traffic between the operator network 15 and the control network 17 with respect to the amount of data transmitted at each point in time (i.e. traffic).

1-16. (canceled)

17. A gateway system for a vehicle, the gateway system comprising:
a gateway configured to control a transmission of data between a first network of the vehicle and a second network of the vehicle in dependence on a state of the vehicle.

18. The gateway system according to claim 17, wherein the first network has an operator network and the second network has a control network.

19. The gateway system according to claim 18, wherein the vehicle is configured to adopt as the state of the vehicle at least:
a maintenance state which is intended for maintenance of the vehicle;
an operating state which is intended for an operation of the vehicle; and
said gateway is configured only to allow a transmission of predetermined data from the operator network to the control network in the maintenance state.

20. The gateway system according to claim 18, wherein said gateway is configured to receive state information representing the state of the vehicle from the control network and to control the transmission on a basis of the state information.

21. The gateway system according to claim 18, wherein said gateway includes:
a first firewall intended for a data interface facing the operator network and is configured to forward or discard data intended for transmission from the operator network to the control network using a first firewall ruleset; and/or
a second firewall intended for a data interface facing the control network and configured to forward or discard data intended for transmission from the control network to the operator network using a second firewall ruleset.

22. The gateway system according to claim 21, wherein said gateway has an intrusion-detector configured to monitor at least data intended for transmission from the operator network to the control network.

23. The gateway system according to claim 22, wherein said gateway has an intrusion-prevention unit configured to prevent transmission of data intended for an unwanted access to the control network.

24. The gateway system according to claim 23, wherein:
said intrusion-detector is configured to carry out monitoring using a first detection ruleset; and/or
said intrusion-prevention unit is configured to carry out prevention using a first prevention ruleset.

25. The gateway system according to claim 18, wherein said gateway has a limiting unit configured to limit data traffic between the operator network and the control network.

26. The gateway system according to claim 24, wherein said gateway has a vehicle-state managing unit which is configured to:
provide said first firewall with a third firewall ruleset in dependence on the state of the vehicle;
provide said intrusion-detector with a second detection ruleset in dependence on the state of the vehicle; and/or
provide said intrusion-prevention unit with a second prevention ruleset in dependence on the state of the vehicle.

27. The gateway system according to claim 26, wherein:
said first firewall is configured to allow, on a basis of the third firewall ruleset, extended access from the operator network to the control network;
said intrusion-detector is configured to allow, on a basis of the second detection ruleset, extended access from the operator network to the control network; and/or
said intrusion-prevention unit is configured to allow, on a basis of the second prevention ruleset, extended access from the operator network to the control network.

28. The gateway system according to claim 27, wherein provision of the third firewall ruleset, the second detection ruleset and/or the second prevention ruleset can only be initiated by information originating from the control network.

29. The gateway device according to claim 17, wherein said gateway has an application-layer gateway configured to convey the data between the first network and the second network.

30. The gateway device according to claim 17, wherein the vehicle is a rail vehicle.

31. The gateway device according to claim 27, wherein provision of the third firewall ruleset, the second detection ruleset and/or the second prevention ruleset can only be initiated by state information originating from the control network and representing the state of the vehicle.

32. A communication method for a vehicle, which comprises the steps of:
transmitting data between a first network of the vehicle and a second network of the vehicle; and
controlling a transmission between the first and second networks by means of a gateway in dependence on a state of the vehicle.

33. A communication system for a vehicle, the communication system comprising:
a first network for the vehicle;
a second network for the vehicle; and
a gateway configured to control transmission of data between said first network and said second network in dependence on a state of the vehicle.

34. A rail vehicle, comprising:
a communication system containing a first network, a second network, and a gateway configured to control transmission of data between said first network and said second network in dependence on a state of the rail vehicle.
